(19) United States
(12) Patent Application Publication
(10) Pub. No.: US 2025/0327547 A1
(43) Pub. Date: Oct. 23, 2025

(54) Compressor With Housing-Integrated Air Storage Device

(71) Applicant: Robert Bosch GmbH, Stuttgart (DE)

(72) Inventors: Daniel White, Bettendorf, IA (US); Jeremy Rubens, Palatine, IL (US); Walter Bernardi, Highland Park, IL (US)

(21) Appl. No.: 19/181,812

(22) Filed: Apr. 17, 2025

Related U.S. Application Data
(60) Provisional application No. 63/636,357, filed on Apr. 19, 2024.

(51) Int. Cl. F17C 1/00; B23B 45/04

(52) U.S. Cl. CPC F17C 1/00; B23B 45/04; F17C 2201/0138; F17C 2203/0624; F17C 2203/0685; F17C 2270/0545; F17C 2270/0563

(57) ABSTRACT

A compressed air storage device has a flexible, elongated tubular configuration in which the tube has an internal volume that is configured to store sufficient compressed air to drive a hand-held pneumatic tool. The compressed air storage device has a variable diameter along its length and an internal space that extends between and communicates with couplings disposed at opposed ends of the device.

### BACKGROUND

Air compressors are commonly used to power a wide range of pneumatic or air-powered tools. Some of the power tools that can be operated using an air compressor include nail guns, impact wrenches, air ratchets, air hammers, drills, sanders and grinders, spray guns, staple guns, et cetera. These are just a few examples of power tools that can be operated using an air compressor. The advantage of pneumatic tools is that they often provide high power and durability while being relatively lightweight and easy to handle. However, air compressors may include a tank to pressurize air and for storage of the pressurized (e.g., compressed) air. Such compressors typically use metal storage tanks that are large, bulky and heavy. This makes them difficult to move and store.

### SUMMARY

In some aspects, a compressed air storage device has a flexible, elongated tubular configuration in which the tube is configured to store compressed air and has an internal volume that is configured to store sufficient compressed air to drive a hand-held pneumatic tool. The tube has a variable diameter along its length. The flexible, tubular compressed air storage device replaces a conventional rigid compressed air storage tank in an air compressor system that also includes an air compressor. The tubular storage device has an internal space that extends between and communicates with couplings disposed at opposed ends of the device.

In some embodiments, the tubular compressed air storage device includes a large diameter portion at a location corresponding to a tube first end that is connected to an air compressor, and a relatively smaller diameter portion at a location corresponding to a tube second end that is connected to a power tool. Although the larger diameter portion permits storage of a larger volume of compressed air, the larger diameter portion is also less flexible than the smaller diameter portion. Providing the smaller diameter portion near the connection to the power tool provides greater flexibility and freedom of movement of the power tool.

In some embodiments, the flexible, tubular compressed air storage device plural large diameter portions that are spaced apart by intermediate portions. The large diameter portions have a much greater diameter than the intermediate portions. The large diameter portions provide increased compressed air storage capacity, and the intermediate portions provide increased flexibility. Since the intermediate portions are spread apart along the length of the air storage device, the entire length of the air storage device has flexibility.

Some conventional compressed air storage tanks 601, 602 have simple curved three dimensional shapes. Some exemplary conventional shapes are shown in FIGS. 7A-C and 8A-C along with a schematic diagram illustrating the forces applied to the tanks by the compressed air stored therein. FIGS. 7A-C illustrate a compressed air storage tank 601 having what is sometimes called a “hot dog” shape, e.g., an elongate, large diameter cylinder having rounded ends. FIGS. 8A-C illustrate a compressed air storage tank 602 having what is sometimes called a “pancake” shape, e.g., a flattened sphere. Since a hand-held pneumatic power tool may require eight liters or more of compressed air to operate, such conventional storage tanks are relatively large in size. The forces on the inner surface of these tanks are equal to the pressure of the compressed air times area of the inner surface. Typical storage tank pressures for air compressors range from 80 to 120 pounds per square inch (psi), while some industrial applications may require higher pressures, reaching up to 200 psi or more. Since the tanks are large to accommodate the required storage volume, the internal forces are also large. For this reason, some conventional compressed air storage tanks are formed of metal and include welded joints. Unfortunately, such tanks are rigid and heavy, ranging from 20 pounds (9 kilograms) to over 100 pounds (45 kilograms), and may be difficult to move from place to place due to their size and weight.

In contrast, the tubular compressed air storage device has a relatively small diameter, for example ranging from 0.25 inches to 1.0 inches in an intermediate region and ranging from 1.0 inches to 10 inches in a large diameter region, whereby the internal pressures of the storage device are relatively small as compared to some conventional storage tanks. In the tubular compressed air storage device, the required volume is achieved by increasing a length of the device. Since the internal pressures are relatively low, the tubular compressed air storage device can be made of flexible and relatively lighter weight materials than those used to make a conventional rigid metal storage tank.

In some aspects, an air compressor system includes an air compressor having an air output, and a compressed air storage device including a multidiameter flexible tube operably connected to the air output and configured to store compressed air.

In some embodiments, the tube includes a first end including a first coupling, and a second end that is opposite the first end, the second end including a second coupling. The tube includes a midpoint that is mid way between the first end and the second end. The tube includes a first diameter portion having a first diameter, the first diameter portion disposed at a location between the first end and the midpoint, and a second diameter portion having a second diameter, the second diameter portion disposed at a location between the midpoint and the second end. The first diameter is greater than the second diameter and the first coupling is connected to the air output.

In some embodiments, the tube comprises an intermediate portion between the first diameter portion and the second diameter portion, and the intermediate portion has a diameter that is less than the second diameter.

In some embodiments, the intermediate portion has greater flexibility than the first diameter portion and the second diameter portion.

In some embodiments, the second coupling is configured to be connected to a power tool.

In some embodiments, the air compressor system includes a hand-held pneumatic power tool, wherein the second coupling is configured to be connected to the power tool.

In some embodiments, the first diameter is at least five times greater than the second diameter.

In some embodiments, the tube has an internal volume that is configured to store sufficient compressed air to drive a hand-held pneumatic tool.

In some embodiments, the air compressor system includes a third diameter portion having a third diameter. The third diameter portion is disposed at a location between the first diameter portion and the second diameter portion, and the third diameter is less than the first diameter.

In some embodiments, the tube comprises a first intermediate portion between the first diameter portion and the third diameter portion and a second intermediate portion between the third diameter portion and the second diameter portion. The first intermediate portion and the second intermediate portion have a diameter that is less than the second diameter.

In some embodiments, the first intermediate portion and the second intermediate portion each have greater flexibility than the first diameter portion, the second diameter portion and the third diameter portion.

In some embodiments, the tube includes plural first diameter portions that are spaced apart by intermediate portions, wherein the first diameter portions have a first diameter and the intermediate portions have a second diameter, and the first diameter is at least twice the second diameter.

In some aspects, a compressed air storage device is configured to be connected to an air output of an air compressor. The compressed air storage device includes a tubular body including a tube first end and a tube second end opposite the first end. The tubular body has a diameter and a length, where the length is equal to the distance between the tube first end and the tube second end when the tubular body is arranged parallel to a line. The length is at least fifty times the diameter. The tubular body has a first diameter at a location between the tube first end and a midpoint of the tubular body. In addition, the tubular body has a second diameter at a location between the midpoint and the tube second end.

In some embodiments, the compressed air storage device includes a second coupling disposed at the tube second end and the second coupling is configured to be connected to a pneumatic power tool.

In some embodiments, the first diameter is at least five times greater than the second diameter.

In some embodiments, the tube includes a first end including a first coupling and a second end that is opposite the first end, the second end including a second coupling. The tube includes a midpoint that is mid way between the first end and the second end. The tube includes a first diameter portion having a first diameter and the first diameter portion is disposed at a location between the first end and the midpoint. The tube includes a second diameter portion having a second diameter and the second diameter portion is disposed at a location between the midpoint and the second end. The first diameter is greater than the second diameter and the first coupling is connected to the air output.

In some embodiments, the tube comprises an intermediate portion between the first diameter portion and the second diameter portion, and the intermediate portion has a diameter that is less than the second diameter.

In some embodiments, the intermediate portion has greater flexibility than the first diameter portion and the second diameter portion.

In some embodiments, the compressed air storage device includes a third diameter portion having a third diameter. The third diameter portion is disposed at a location between the first diameter portion and the second diameter portion and the third diameter is less than the first diameter.

In some embodiments, the tube comprises a first intermediate portion between the first diameter portion and the third diameter portion and a second intermediate portion between the third diameter portion and the second diameter portion. The first intermediate portion and the second intermediate portion have a diameter that is less than the second diameter.

In some embodiments, the first intermediate portion and the second intermediate portion each have greater flexibility than the first diameter portion, the second diameter portion and the third diameter portion.

### BRIEF DESCRIPTION OF THE DRAWINGS

FIG. 1 is a perspective view of system for supplying compressed air to a hand-held power tool including an air compressor, a compressed air storage device and a pneumatic power tool.

FIG. 2 is a schematic diagram of the system of FIG. 1 in which a single line represents an electrical connection and a double line represents a fluid connection.

FIG. 3 is a cross-sectional view of the tube of the compressed air storage device as seen along line 3-3 of FIG. 1 in which arrows are used to represent lines of force on an inner surface of the tube.

FIG. 4A is a perspective view of system of FIG. 1 illustrating the compressed air storage device in an alternative orientation.

FIG. 4B is a graph of the air pressure in the air storage device over time for two different air storage device configurations.

FIG. 5 is a perspective view of an alternative embodiment of the compressed air storage device.

FIG. 6 is a perspective view of another alternative embodiment compressed air storage device.

FIG. 7A is a perspective view of a conventional air compressor including a “hot dog” shaped conventional compressed air storage tank, FIG. 7B is a schematic illustration of the general shape of the tank of FIG. 7A and FIG. 7C is a cross-sectional view of FIG. 7B as seen along line 7C-7C in which arrows are used to represent lines of force on an inner surface of the tank.

FIG. 8A is a perspective view of a conventional air compressor including a “pancake” shaped conventional compressed air storage tank, FIG. 8B is a schematic illustration of the general shape of the tank of FIG. 8A and FIG. 8C is a cross-sectional view of FIG. 8B as seen along line 8C-8C in which arrows are used to represent lines of force on an inner surface of the tank.

### DETAILED DESCRIPTION

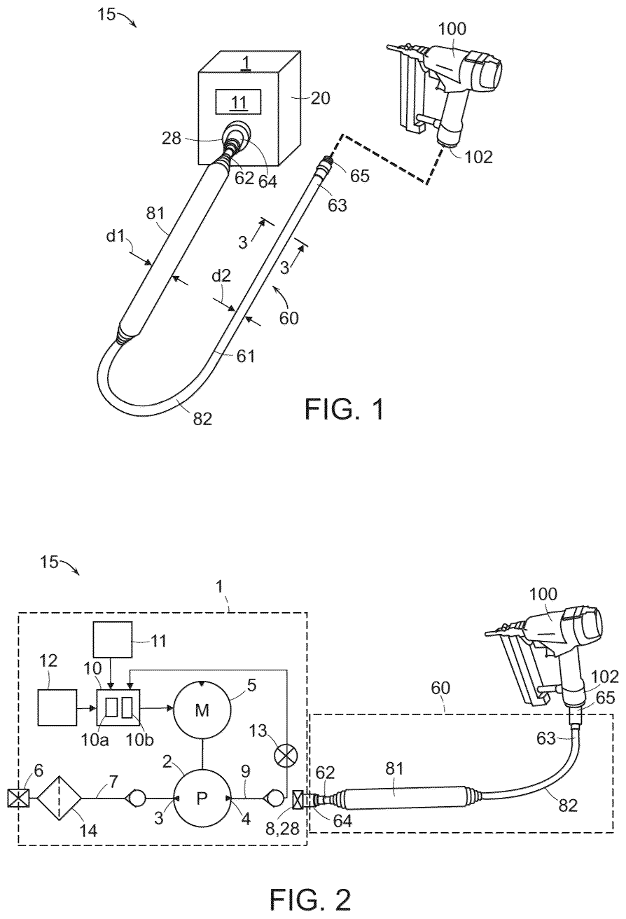

Referring to FIGS. 1 and 2, a power tool system 15 includes a compressed air-driven power tool 100, an air compressor 1, and a compressed air storage device 60. The power tool 100 may be a hand-held tool such as a nail gun, an impact wrench, an air ratchet, an air hammer, an air drill, an air sander, an air grinder, a spray gun, a staple gun, or any other air driven power tool. The power tool 100 is directly connected to the air compressor 1 via the compressed air storage device 60. In the illustrated embodiment, the compressed air storage device 60 is an elongate, flexible tube 61 that is configured to store air that has been compressed to pressures of 50 to 300 pounds per square inch (PSI) or more and to provide a reservoir for a steady supply of pressurized air to the power tool 100 during tool operation. The air compressor 1 includes a compressor housing 20 including fluid couplings that permit fluid tight connection to the air storage device 60. The tube 61 has a variable diameter along its length and is sufficiently flexible to permit bending and/or coiling and is sufficiently light to be easily moved and manipulated by a user of the power tool 100. The air compressor 1 and compressed air storage device 60 will now be described in detail.

The air compressor 1 may be a positive displacement compressor such as a provided by a reciprocating piston pump but is not limited to this type of pump. The air compressor 1 includes a compressor housing 20 that encloses and/or supports the other components of the air compressor 1, including a compressor pump 2, a motor 5, a controller 10, a human machine interface (HMI) 11, a battery 12, a pressure regulation device 13 and other ancillary components required for operation of the air compressor 1.

In the illustrated embodiment, the compressor pump 2 is a reciprocating piston pump, but may be another type of positive displacement pump. The compressor pump 2 uses one or more reciprocating pistons (not shown) to compress air. The compressor pump 2 includes an air inlet 3 and an air outlet 4.

The air inlet 3 is connected to a compressor air intake valve 6 via a first fluid line 7. The air intake valve 6 is supported on the compressor housing 20. When the air intake valve 6 is in an open position, air in the environment of the air compressor 1 (e.g., air at atmospheric pressure) is permitted to enter first fluid line 7. When the air intake valve 6 is in a closed position, air in the environment of the air compressor 1 is prevented from entering the first fluid line 7. An air filter 14 may be provided in the first fluid line 7 at a location between the air intake valve 6 and the pump air inlet 3.

The air outlet 4 is connected to a compressor air exhaust valve 8 via a second fluid line 9. The air exhaust valve 8 is supported on the compressor housing 20 and includes an integrated fluid coupling. When the air exhaust valve 8 is in an open position, air that has been compressed by the compressor pump 2 is permitted to exit the compressor housing 20. If the compressed air storage device 60 is coupled to the air exhaust valve fluid coupling, air that has been compressed by the compressor pump 2 is permitted to enter the compressed air storage device 60. When the air exhaust valve 8 is in a closed position, compressed air is prevented from exiting the compressor housing 20.

The pressure regulation device 13 is configured to monitor the output pressure of the air compressor 1. In the illustrated embodiment, the pressure regulation device 13 may be a pressure switch that monitors the pressure of the fluid exhausted from the compressor pump 2 and outputs a signal to the controller indicating the detected pressure. For example, the pressure switch may detect the pressure of the second fluid line 9 at a location between the compressor pump 2 and the compressor exhaust valve 8.

The motor 5 is an electric motor. In some embodiments, the motor 5 may be an induction motor, but is not limited to this type of motor. An output shaft (not shown) of the motor 5 is connected to the compressor pump 2 and motor 5 drives the pump 2 to compress air.

In the illustrated embodiment, a battery 12 is included in the compressor housing 20 and supplies power to the controller 10, which in turn supplies power to the motor 5. The battery 12 may be a rechargeable battery that is charged via a detachable wired connection to utility power. In some embodiments, the air compressor 1 may omit the battery 12 and obtain power via a direct wired connection to utility power. In still other embodiments, the air compressor 1 may include the battery 12 and be capable of being powered by either the battery 12 or direct connection to utility power.

The controller 10 is communicatively coupled with the HMI 11, the battery 12 and the pressure regulation device 13 and is configured to control the motor 5 based on these inputs. As used herein, the term “communicatively coupled” may refer to a direct wired connection via for example electrically conductive signal lines, shared communication busses, or alternatively may refer to a wireless connection. Thus, controller 10 can receive information from these devices and selectively activate and operate the various operational components.

In some embodiments, controller 10 includes one or more memory devices 10a and one or more processors 10b. The processors 10b may be any combination of general or special purpose processors, CPUs, or the like that can execute programming instructions or control code associated with operation of the air compressor 1. The memory devices (i.e., memory) 10a may represent random access memory such as DRAM or read only memory such as ROM or FLASH. In some embodiments, the processor 10b executes programming instructions stored in memory 10a. The memory 10a may be a separate component from the processor 10b or may be included onboard within the processor 10b. Alternatively, the controller 10 may be constructed without using a processor 10b, for example, using a combination of discrete analog or digital logic circuitry (such as switches, amplifiers, integrators, comparators, flip-flops, AND gates, and the like) to perform control functionality instead of relying upon software.

In some embodiments, the controller 10 includes a network interface such that the controller 10 can connect to and communicate over one or more networks (not shown). The controller 10 may also include one or more transmitting, receiving, or transceiving components for transmitting and/or receiving communications with other devices communicatively coupled with the air compressor 1. Additionally, or alternatively, the transmitting, receiving, or transceiving components can be located off board controller 10. Generally, the controller 10 may be positioned in any suitable location throughout the compressor housing 20.

The various functions performed by the controller 10 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The compressor housing 20 includes an interior vacancy that receives and supports the compressor pump 2, the motor 5, the air filter 14, the pressure regulation device 13, the HMI 11, the controller 10, the air intake and exhaust valves 6, 8 and any ancillary components needed for compressor operation.

The HMI 11 is mounted on an outer surface of the compressor housing 20 and may include switches or other input devices and/or a display. The HMI 11 is configured to permit the user to operate the air compressor 1 and receive information about air compressor performance. In some embodiments, the display may be colored, non-colored (e.g., gray-scale), or a combination of both. The display may be implemented as any type of display including a liquid crystal display (LCD), light emitting diodes (LED), organic light emitting diodes (OLED) or any other alternative configuration known to one of ordinary skill in the art. The display may provide touch-screen functionality and an air pressure level selector may be integrated into the HMI 11.

In the illustrated embodiment, the air exhaust valve 8 terminates in a hose coupling 28 that protrudes from the compressor housing 20 at a location adjacent to the HMI but is not limited to this location. The hose coupling 28 is configured to provide a fluid tight mechanical connection to a first coupling 64 of the air storage device 60. In addition, in some embodiments, the hose coupling 28 may include 360 degree, bidirectional swivel functionality such that the air storage device 60 is capable of rotation relative to the compressor housing.

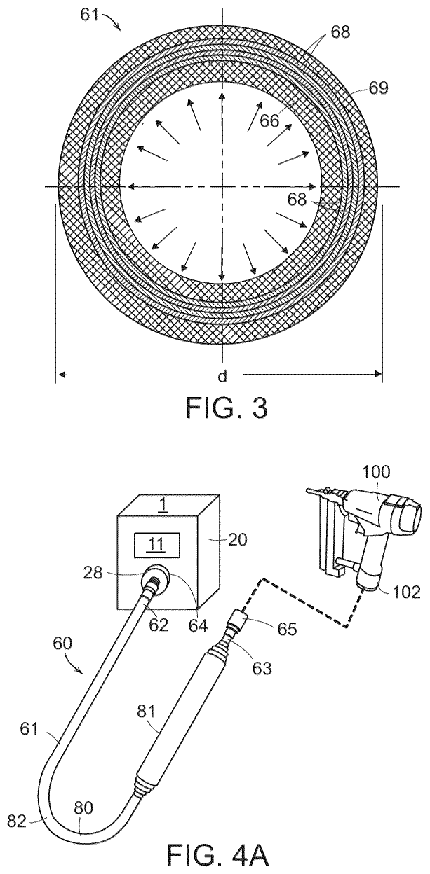

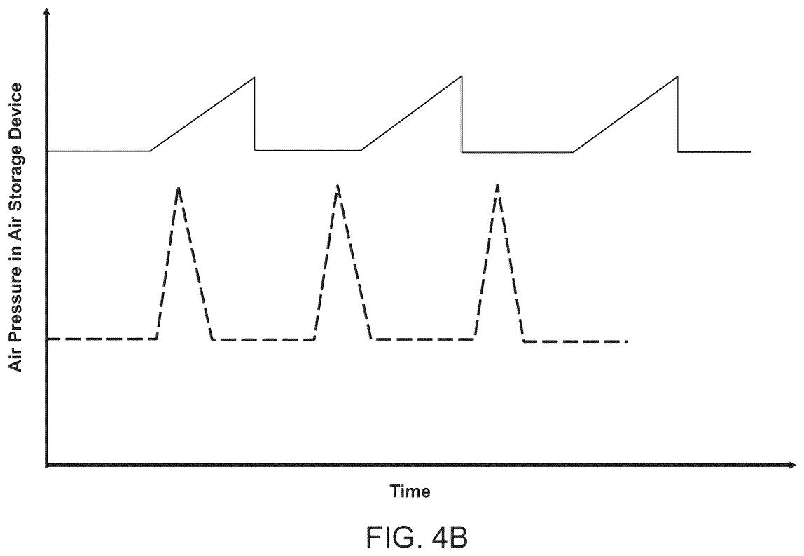

Referring also to FIGS. 3 and 4, the air storage device 60 is an elongated tube 61 having a device first end 62 that is detachably coupled to the hose coupling 28 of the air exhaust valve 8 via a device first coupling 64. The tube 61 includes a device second end 63 that is opposite the device first end 62. The device second end 63 includes a device second coupling 65. In addition, the tube 61 includes a midpoint 80 that is disposed mid-way between the device first end 62 and the device second end 63.

The element first coupling 64 is configured to be detachably connected to the hose coupling 28 of the air compressor 1 in a fluid-tight manner, for example using a quick connect fitting suitable for high pressure applications. Similarly, the element second coupling 65 is configured to be detachably connected to the tool coupling 102 in a fluid tight manner, for example using a quick connect fitting suitable for high pressure applications. Alternatively, other fitting types such as threaded or barbed fitting could be employed when appropriate.

The tube 61 is elongated. In particular, the tube diameter d is much smaller than a length (not shown) of the tube 61, where the length of the tube corresponds to a distance between the tube first and second ends 62, 63. The tube length is at least 10 times the diameter d of the tube 61. In some embodiments, the tube length is more than 50 times the diameter d of the tube 61.

The size and capacity of the tube 61 may depend on factors such as the output capacity of the air compressor 1, the required air pressure, and the specific application's air demand (for example, the pressure required by the power tool 100). In some embodiments, the air storage device 60 has sufficient capacity to handle the required tool operating (including firing) pressure and to provide sufficient storage capacity to meet the needs of the compressed air system. Increasing tube interior space volume by providing a tube 61 of increased length is one way to accomplish increased storage capacity. Another way to increase tube interior space volume is to provide the tube with regions of increased diameter. For this reason, the tube 61 has a variable diameter along its length.

In the embodiment illustrated in FIGS. 1 and 2, the tube 61 of the air storage device 60 includes a first diameter portion 81 having a first diameter d1 and a second diameter portion 82 having a second diameter d2. The first diameter portion 81 is disposed at a location between the device first end 62 and the midpoint 80. In some embodiments, the first diameter portion 81 includes the device first end 62 and terminates before the midpoint 80. The second diameter portion 82 extends from the first diameter portion 81 to the device second end 63 and includes the device second end 63. The first diameter d1 is greater than the second diameter d2. In some embodiments, the second diameter d2 is in a range of 0.25 inches to 1.00 inches, and the first diameter is at least five times the second diameter d2. Due to the greater volume, the first diameter portion 81 is less flexible than the second diameter portion 82. For example, the first diameter portion 81 may bend to a radius of 50 inches or more (e.g., it has relatively low flexibility), whereas the second diameter portion 82 may bend to a radius in a range of two inches to ten inches (e.g., it has relatively high flexibility). In this embodiment, the portion of the air storage device 60 that is closest to the power tool 100 has the greatest flexibility, facilitating the mobility of the power tool 100 and providing ease of manipulation and/or positioning of the power tool 100 during use.

Although the air storage device 60 is shown in FIGS. 1 and 2 with the device first coupling 64 connected to the hose coupling 28 of the air compressor 1 and with the device second coupling 65 connected to the tool coupling 102, the air storage device 60 is not limited to this configuration. For example, as shown in FIG. 4A, the air storage device 60 may be used in the opposite orientation. In FIG. 4A, the device first coupling 64 is connected to the tool coupling 102 and the device second coupling 65 is connected to the hose coupling 28 of the air compressor 1. In this orientation, the larger first diameter portion 81 is located closely adjacent to the power tool 100. Advantageously, this orientation improves tool performance since the compressed air reservoir within the first diameter portion 81 is close to the power tool 100 whereby pressure losses due to fluid travel through the interior of the tube 61 is reduced.

Referring to FIG. 4B, a graph of the air pressure in the air storage device 60 over time during operation of a power tool such as a nail gun illustrates the effect of the position of the first diameter portion 81 along the length of the tubular body 81. Both the solid and broken lines represent air pressure in the air storage device having a variable tube diameter. The solid line represents the pressure versus time in an air storage device 60 configured so that the first diameter portion 81 is located closely adjacent to the compressor 1, for example as shown in FIG. 2. The broken line represents the pressure versus time in an air storage device 60 configured so that the larger first diameter portion 81 is located closely adjacent to the power tool 100, for example as shown in FIG. 4A. In both configurations, a spike in pressure occurs as air is rushing into the power tool and the tool is fired. When the first diameter portion 81 is located closely adjacent to the compressor 1 and further from the power tool 100, it takes longer to fill the power tool 100 with air and thus takes longer to fire. This is because the air needs to travel out of the first diameter portion 81 of the air storage device 60 and then through the second diameter portion 82 where it meets resistance. The resistance results in a pressure drop and thus a reduced maximum amplitude and a slower firing rate as it takes longer to fill up the tool firing chamber and activate the power tool 100 as a result of the pressure drop. When the larger first diameter portion 81 is located closely adjacent to the power tool 100 and further from the compressor 1, the opposite is true. In this case, the compressed air is transferred quickly and results in a higher pressure because there is less pressure drop between the first diameter portion 81 and the power tool 100.

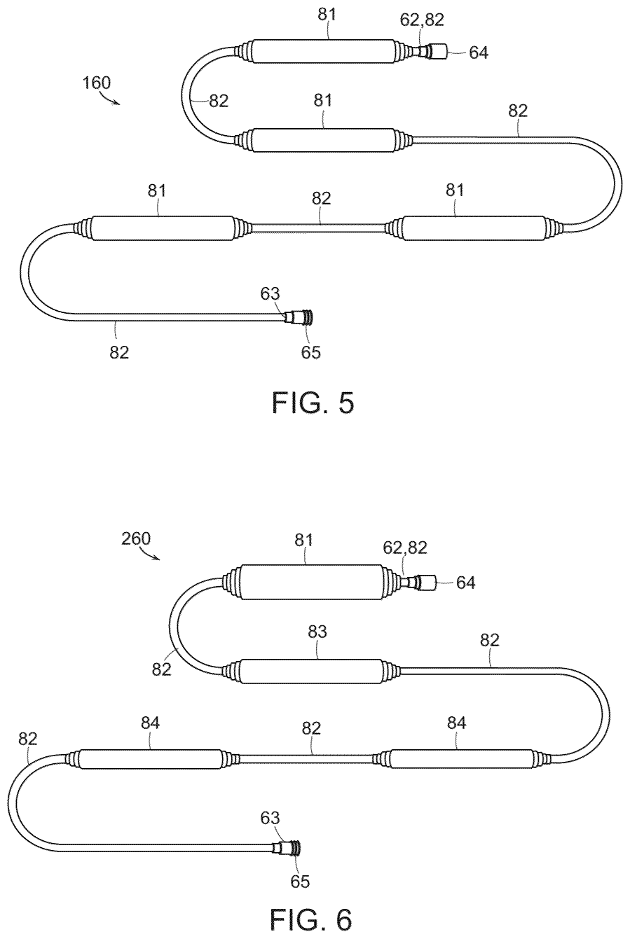

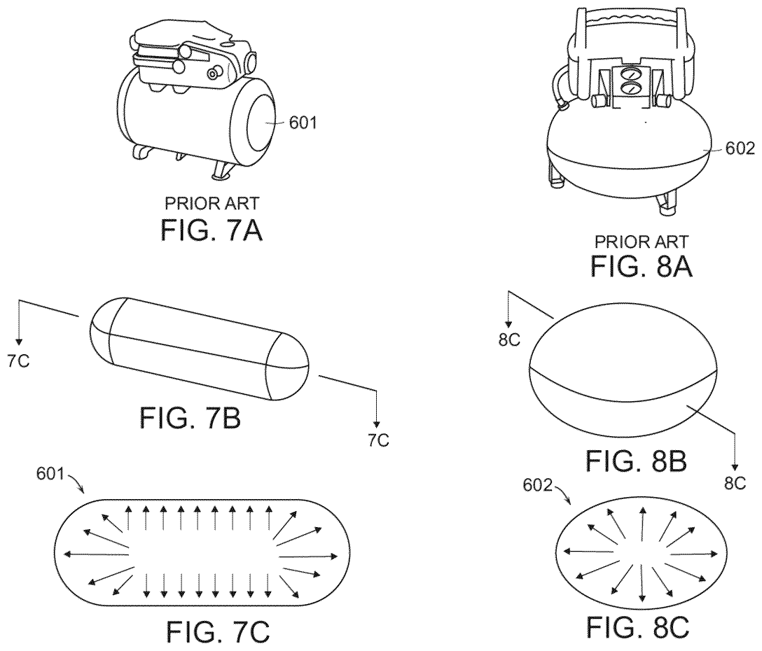

Referring to FIG. 5, an alternative embodiment air storage device 160 is similar to the air storage device 60 of FIGS. 1-3, and common reference numbers are used to refer to common elements. The air storage device 160 shown in FIG. 4 differs from the previous embodiments in that the air storage device 160 includes a plurality of first diameter portions 81. The relatively large first diameter portions 81 are spaced apart and are connected in series by intermediate second diameter portions 82. In addition, the device first and second ends 62, 63 along with the corresponding first and second couplings 64, 65 are each included in a second diameter portion 82. In one non-limiting example, in an air storage device in which a distance between the device first and second ends 62, 63 is 25 feet (7.62 m), a length of the second diameter portions 82 (e.g., the distance between adjacent first diameter portions 81) may be in a range of 3 inches (75 mm) to 7 inches (178 mm). Since the second diameter portions are relatively flexible, this configuration provides increased storage volume while maintaining flexibility along the length of the tube 61.

Referring to FIG. 6, another alternative embodiment air storage device 260 is similar to the air storage device 160 of FIG. 5, and common reference numbers are used to refer to common elements. The air storage device 260 shown in FIG. 6 differs from the previous embodiments in that the air storage device 260 includes at least one first diameter portion 81, at least one third diameter portion 83 having a third diameter d3 and at least one fourth diameter portion 84 having a fourth diameter d4. The third diameter d3 is less than the first diameter d1 and greater than the fourth diameter d4. The third and fourth diameters d3, d4 are greater than the second diameter d2. In this embodiment, the relatively large first, third and fourth diameter portions 81, 83, 84 are spaced apart and are connected in series by intermediate second diameter portions 82. As in the previous embodiment, the device first and second ends 62, 63 along with the corresponding couplings 64, 65 are each included in a second diameter portion 82. Since the second diameter portions are relatively flexible, this configuration provides increased storage volume while maintaining flexibility along the length of the tube 61 but may be lighter than the air storage device 160 shown in FIG. 5. Moreover, the third and fourth diameter portion 83, 84 may be more flexible than the first diameter portion 81, whereby the air storage device 260 may be more flexible than the air storage device 160 of FIG. 5.

The tube 61 has an interior volume that is sufficient to power a pneumatic power tool, which may require a storage capacity of eight liters or more to maintain a high airflow applications. However, most pneumatic tools are operable at lower capacities. Nail guns, for example, may be operable using a one liter capacity or less, depending on the specific tool, the compressor used and required recharge period. Providing the tube 61 with a varying diameter permits use of a tubular air storage device while providing a compact air storage configuration.

Referring to FIG. 3, the tube 61 is constructed using multiple layers of materials to ensure durability, flexibility, and resistance to high-pressure air. In the illustrated embodiment, the tube 61 includes an inner tube 66, at least one reinforcement layer 68 and an outer tube 69. The innermost layer of the tube 61 is the inner tube 66, which is responsible for carrying the compressed air. The inner tube 66 may be made of synthetic rubber or a similar material that can withstand high-pressure air and resist degradation from oil or moisture. The reinforcement layer(s) 68 surround the inner tube 66 and provides strength and stability to the tube 61. In the illustrated embodiment, there are four reinforcement layers 68. Each reinforcement layer may be made of braided or spiraled metal fibers or synthetic fibers, such as polyester or nylon. The reinforcement layers 68 help the tube 61 withstand the internal pressure cause by compressed air and prevent the tube 61 from expanding or bursting. The outermost layer of the tube 61 is the outer tube 69 or cover, which protects the inner layers 66, 68 from external damage, abrasion, and exposure to the elements. The outer tube 69 may be made of synthetic rubber or a blend of rubber and other materials. The outer tube 69 is designed to be resistant to oil, chemicals, UV rays, and general wear and tear. The construction of the tube 61 may vary depending on the specific application and the desired flexibility.

The compressed air storage device first and second couplings 64, 65 are connectors or fittings that allow for easy attachment to the compressor and other pneumatic tools or equipment. The device first and second couplings 64, 65 fittings may be made of brass, steel, or other durable materials and are typically threaded or equipped with quick-connect mechanisms for secure and leak-free connections.

In some embodiments the tube 61 is a unitary or monolithic structure from the device first end 62 to the device second end 63. In other embodiments, the tube 61 may be an assembly of individual sections that are attached in series using pressure fittings. For example, a fluid connection between a flexible intermediate portion (e.g., a second diameter portion 81) and a relatively larger portion (e.g., a first diameter portion 82) may be achieved using a pressure fitting. In some embodiments, the relatively larger portion may be formed of the same material as the intermediate portion and may have some limited flexibility depending on the stored pressure. In other embodiments, the relatively larger portion may be formed of a different material. For example, the relatively larger portion may be a rigid metal cannister. In this example, the relatively larger portion has minimum flexibility, and all the flexibility of the air storage device is achieved by the intermediate portion(s). This permits the tube 61 to be assembled by the user in a variety of configurations, enabling the user to adjust storage capacity, flexibility and length.

Although each of the illustrated embodiments show alternating larger and smaller diameter portions, the air storage device 60, 160, 260 is not limited to this configuration. In particular, any portion may be connected to any other portion regardless of diameter.

In the power tool system 15, the power tool 100 is directly connected to the air compressor 1 via the compressed air storage device 60, 160, 260. That is to say, the device first coupling 64 is directly connected to the coupling of the air exhaust valve 8 of the air compressor 1 with no intervening structures or devices. In addition, the device second coupling 65 is directly connected to the tool coupling 102 of the power tool 100 with no intervening structures or devices. Moreover, the compressed air storage device 60 stores compressed air for driving the power tool 100 during use.

Selective illustrative embodiments of the compressed air supply system including the air compressor and the air storage device are described above in some detail. It should be understood that only structures considered necessary for clarifying the compressed air supply system have been described herein. Other conventional structures, and those of ancillary and auxiliary components of the compressed air supply system are assumed to be known and understood by those skilled in the art. Moreover, while a working example of the compressed air supply system has been described above, the system is not limited to the working example described above, but various design alterations may be carried out without departing from the system and/or the components thereof as set forth in the claims.

1. An air compressor system comprising:
an air compressor having an air output, and
a compressed air storage device including a multidiameter flexible tube operably connected to the air output and configured to store compressed air.

2. The air compressor system of claim 1, wherein the tube includes
a first end including a first coupling,
a second end that is opposite the first end, the second end including a second coupling,
a midpoint that is mid way between the first end and the second end,
a first diameter portion having a first diameter, the first diameter portion disposed at a location between the first end and the midpoint,
a second diameter portion having a second diameter, the second diameter portion disposed at a location between the midpoint and the second end,
the first diameter is greater than the second diameter,
and the first coupling is connected to the air output.

3. The air compressor system of claim 2, wherein the tube comprises an intermediate portion between the first diameter portion and the second diameter portion, and the intermediate portion has a diameter that is less than the second diameter.

4. The air compressor of claim 3, wherein the intermediate portion has greater flexibility than the first diameter portion and the second diameter portion.

5. The air compressor system of claim 2, wherein the second coupling is configured to be connected to a power tool.

6. The air compressor system of claim 2, comprising a hand-held pneumatic power tool, wherein the second coupling is configured to be connected to the power tool.

7. The air compressor system of claim 2, wherein the first diameter is at least five times greater than the second diameter.

8. The air compressor system of claim 2, wherein the tube has an internal volume that is configured to store sufficient compressed air to drive a hand-held pneumatic tool.

9. The air compressor system of claim 2, comprising a third diameter portion having a third diameter, the third diameter portion disposed at a location between the first diameter portion and the second diameter portion, and wherein the third diameter is less than the first diameter.

10. The air compressor system of claim 9, wherein the tube comprises a first intermediate portion between the first diameter portion and the third diameter portion and a second intermediate portion between the third diameter portion and the second diameter portion, and the first intermediate portion and the second intermediate portion have a diameter that is less than the second diameter.

11. The air compressor system of claim 10, wherein the first intermediate portion and the second intermediate portion each have greater flexibility than the first diameter portion, the second diameter portion and the third diameter portion.

12. The air compressor system of claim 1, wherein the tube includes plural first diameter portions that are spaced apart by intermediate portions, wherein the first diameter portions have a first diameter and the intermediate portions have a second diameter, and the first diameter is at least twice the second diameter.

13. A compressed air storage device configured to be connected to an air output of an air compressor, the compressed air storage device comprising:
a tubular body including a tube first end and a tube second end opposite the first end,
the tubular body having a diameter and a length, where the length is equal to the distance between the tube first end and the tube second end when the tubular body is arranged parallel to a line, the length being at least fifty times the diameter,
the tubular body has a first diameter at a location between the tube first end and a midpoint of the tubular body,
the tubular body has a second diameter at a location between the midpoint and the tube second end.

14. The compressed air storage device of claim 1, wherein the compressed air storage device includes a second coupling disposed at the tube second end and the second coupling is configured to be connected to a pneumatic tool.

15. The compressed air storage device of claim 1, wherein the first diameter is at least five times greater than the second diameter.

16. The compressed air storage device of claim 13, wherein the tube includes
a first end including a first coupling,
a second end that is opposite the first end, the second end including a second coupling,
a midpoint that is mid way between the first end and the second end,
a first diameter portion having a first diameter, the first diameter portion disposed at a location between the first end and the midpoint,
a second diameter portion having a second diameter, the second diameter portion disposed at a location between the midpoint and the second end,
the first diameter is greater than the second diameter,
and the first coupling is connected to the air output.

17. The compressed air storage device of claim 16, wherein the tube comprises an intermediate portion between the first diameter portion and the second diameter portion, and the intermediate portion has a diameter that is less than the second diameter.

18. The compressed air storage device of claim 17, wherein the intermediate portion has greater flexibility than the first diameter portion and the second diameter portion.

19. The compressed air storage device of claim 16, comprising a third diameter portion having a third diameter, the third diameter portion disposed at a location between the first diameter portion and the second diameter portion, and wherein the third diameter is less than the first diameter.

20. The compressed air storage device of claim 19, wherein the tube comprises a first intermediate portion between the first diameter portion and the third diameter portion and a second intermediate portion between the third diameter portion and the second diameter portion, and the first intermediate portion and the second intermediate portion have a diameter that is less than the second diameter.

21. The compressed air storage device of claim 20, wherein the first intermediate portion and the second intermediate portion each have greater flexibility than the first diameter portion, the second diameter portion and the third diameter portion.
